(19) United States
(12) Patent Application Publication
(10) Pub. No.: US 2011/0248845 A1
(43) Pub. Date: Oct. 13, 2011

(54) Architecture for Controlling Signal Lights of Vehicles

(76) Inventors: CHIU-SAN LEE, New Taipei City (TW); Yi-Hsun Lee, New Taipei City (TW)

(21) Appl. No.: 13/165,808

(22) Filed: Jun. 22, 2011

Related U.S. Application Data
(63) Continuation-in-part of application No. 12/166,838, filed on Jul. 2, 2008.

(51) Int. Cl. B60Q 1/26

(52) U.S. Cl. 340/468

(57) ABSTRACT

An architecture for controlling signal lights of vehicles comprises a control assembly, a movable shaft, and a warning signal switch. The warning signal switch is arranged corresponding to the third connecting means and the movable shaft, the warning signal switch being electrically connected to the first signal indicator and the second signal indicator. The warning signal switch can be operated in cooperation with a movement of the movable shaft with respect to the control assembly so that the signal indicators can function as either a directional indicator or a warning indicator, and the function of directional indication will not be overridden by that of warning indication, for improving the safety of driving vehicles. Furthermore, the architecture can simplify the components and wiring thereof to achieve an economical design.

### CROSS-REFERENCE TO RELATED APPLICATION

This is a continuation-in-part of the co-pending patent application Ser. No. 12/166,838, owned by the same applicant.

### (a) TECHNICAL FIELD OF THE INVENTION

The present invention relates to an architecture for controlling signal lights of vehicles, and more particular to an architecture that can avoid the function of directional indication being overridden by that of warning indication for improving the safety of driving vehicles and can simplify the components and wiring thereof.

### (b) DESCRIPTION OF THE PRIOR ART

The signal lights of a vehicle can be used as a directional indicator for showing a turning direction of the vehicle or a warning indicator for showing an abnormal condition of the vehicle. Generally, a vehicle is provided with a directional signal switch and a warning signal switch to control the signal lights thereof. However, when both switches of the vehicle are switched on at the same time, the function of showing a warning will override that of showing a turning direction. In such condition, all the signal lights of the vehicle will be turned on to flicker at the same time, so that the tuning direction of the vehicle will be unknown, and this may be a potential risk of driving the vehicle. The applicant had mitigated the problem to allow the signal lights of a vehicle to function as a directional indicator when a driver activates the directional signal switch. However, the applicant deems that the modified light control device has some drawbacks, which can be further mitigated, as follows:

1. The modified light control device cannot be operated conveniently, as the components and electrical wiring thereof is complex.

2. The modified light control device is less economical, as the installing procedure therefor is complex.

In view of the drawbacks of the modified light control device, the applicant collected relevant information and considered some aspects of the device. Base on long-term experiences of vehicle products and after constant efforts on test and modification, the applicant has contrived an architecture for controlling signal lights of vehicles, whereby the function of directional indication will not overridden by that of warning indication to avoid a potential risk of driving vehicles, and the components and wiring thereof can be simplified to achieve an economical design.

### SUMMARY OF THE INVENTION

The primary object of the present invention is to provide an architecture for controlling signal lights of vehicles, which can avoid the function of directional indication being overridden by that of warning indication to improve the safety of driving vehicles and can simplify the components and wiring of thereof.

The secondary object of the present invention is to provide an architecture for controlling signal lights of vehicles, which is economical and can be installed easily.

To achieve the above objects, an architecture for controlling signal lights of vehicles comprises a control assembly, a movable shaft, and a warning signal switch. The control assembly includes a first connecting means for controlling a first signal indicator, a second connecting means for controlling a second signal indicator, and a third connecting means for controlling the first signal indicator and the second signal indicator. The control assembly is mounted with conducting pads and insulating members for the first connecting means, the second connecting means, and the third connecting means. The movable shaft is provided with at least one conducting portion for cooperating with the first connecting means, the second connecting means, and the third connecting means to generate a corresponding effect of signal indication.

The first connecting means includes a first conducting strip matchable with the conducting portion of the movable shaft and a first electrical line being arranged corresponding to the first conducting strip and being electrically connected to the first signal indicator. When the conducting portion of the movable shaft is positioned corresponding to the first conducting strip of the first connecting means and the conducting pad, the first signal indicator can be turned on to flicker by engaging the first conducting strip with the first electrical line to form an electrical loop.

The second connecting means includes a second conducting strip matchable with the conducting portion of the movable shaft and a second electrical line being arranged corresponding to the second conducting strip and being electrically connected to the second signal indicator. When the conducting portion of the movable shaft is positioned corresponding to the second conducting strip of the second connecting means and the conducting pad, the second signal indicator can be turned on to flicker by engaging the second conducting strip with the second electrical line to form an electrical loop.

Furthermore, a warning signal switch is arranged corresponding to the third connecting means and the movable shaft, the warning signal switch being electrically connected to the first signal indicator and the second signal indicator. The third connecting means includes a third conducting strip matchable with the conducting portion of the movable shaft and a third electrical line being arranged corresponding to the third conducting strip and being electrically connected to the warning signal switch. When the warning signal switch is switched on and the conducting portion of the movable shaft is positioned corresponding to the third conducting strip of the third connecting means and the conducting pad, the first signal indicator and the second signal indicator can be turned on to flicker at the same time by engaging the third conducting strip with the third electrical line to form two electrical loops. When the warning signal switch is switched off and the conducting portion of the movable shaft is positioned corresponding to the third conducting strip of the third connecting means and the conducting pad, the first signal indicator and the second signal indicator will keep at off state due to the warning signal switch being switched off.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic view showing a first state of the present invention, in which both of signal indicators are turned on to flicker, and the present invention is functioned as a warning indicator.

FIG. 1A is a schematic enlarged view showing the control assembly under the first state of the present invention.

FIG. 2 is a schematic view showing a second state of the present invention, in which the first signal indicator is turned on to flicker, and the present invention is functioned as a directional indicator.

FIG. 2A is a schematic enlarged view showing the control assembly under the second state of the present invention.

FIG. 3 is a schematic view showing a third state of the present invention, in which the second signal indicator is turned on to flicker, and the present invention is functioned as a directional indicator.

FIG. 3A is a schematic enlarged view showing the control assembly under the third state of the present invention.

FIG. 4 is a schematic view showing a fourth state of the present invention, in which the warning signal switch is switched off, and both of the signal indicators are keep at off state.

FIG. 5 is a schematic view showing a fifth state of the present invention, in which the warning signal switch is switched off, and the first signal indicator is turned on to flicker.

FIG. 6 is a schematic view showing a sixth state of the present invention, in which the warning signal switch is switched off, and the second signal indicator is turned on to flicker.

### DETAILED DESCRIPTION OF THE PREFERRED EMBODIMENTS

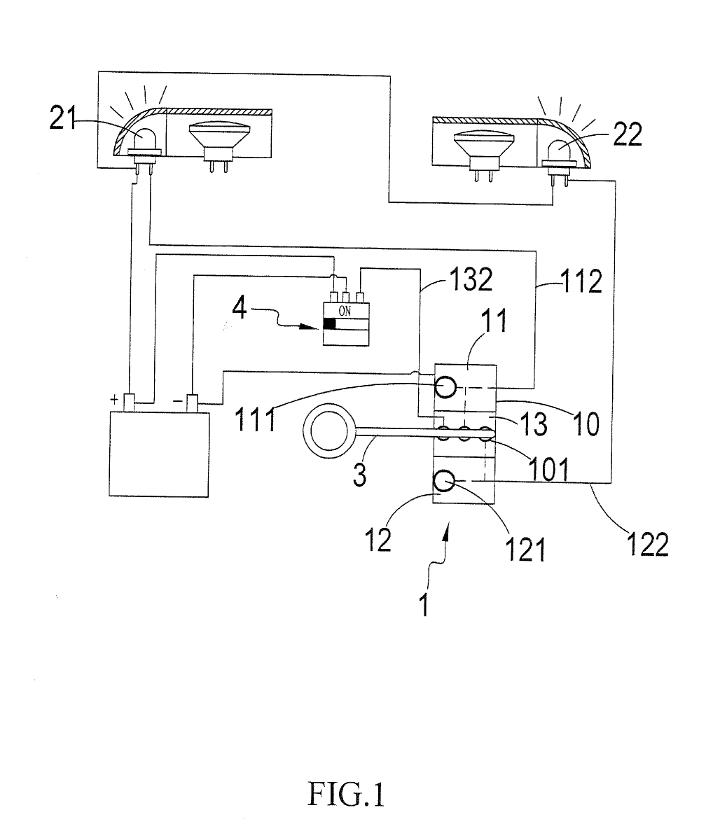

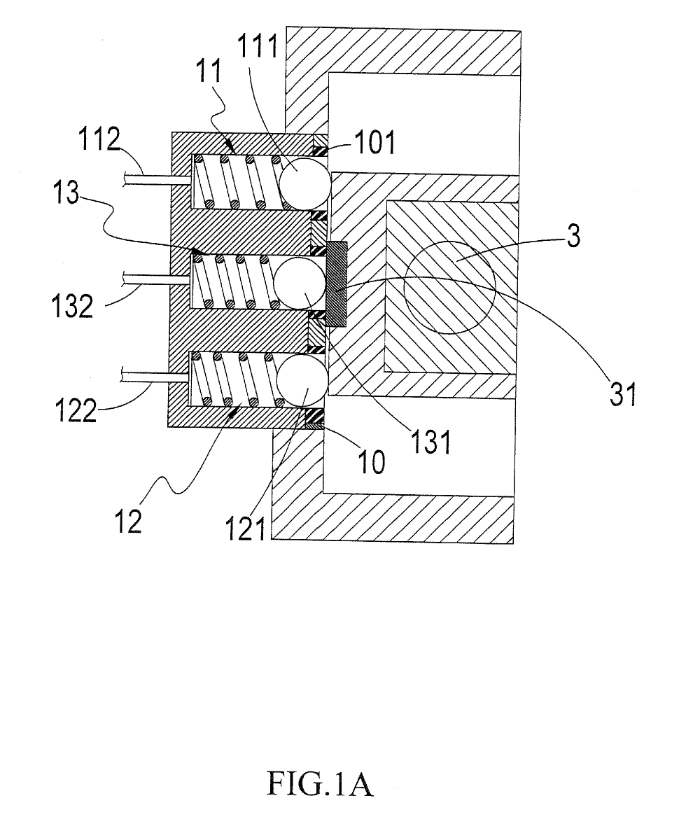

Referring to FIGS. 1 and 1A, an architecture for controlling signal lights of vehicles according to the present invention generally comprises a control assembly 1, an movable shaft 3, and a warning signal switch 4. The control assembly 1 includes a first connecting means 11 for controlling a first signal indicator 21, a second connecting means 12 for controlling a second signal indicator 22, and a third connecting means 13 for controlling the first signal indicator 21 and the second signal indicator 22. The control assembly 1 is mounted with conducting pads 10 and insulating members 101 for the first connecting means 11, the second connecting means 12, and the third connecting means 13. As shown, the first connecting means 11 and the second connecting means 12 are respectively located at two end sections of the control assembly 1 for each corresponding to a turning direction of a vehicle, while the third connecting means 13 is located at a middle section of the control assembly 1. The movable shaft 3 is provided with at least one conducting portion 31, which can cooperate with the first connecting means 11, the second connecting means 12, and the third connecting means 13 respectively to generate a corresponding effect of signal indication. The warning signal switch 4, which is arranged corresponding to the third connecting means 13 and the movable shaft 3, is electrically connected to the first signal indicator 21 and the second signal indicator 22.

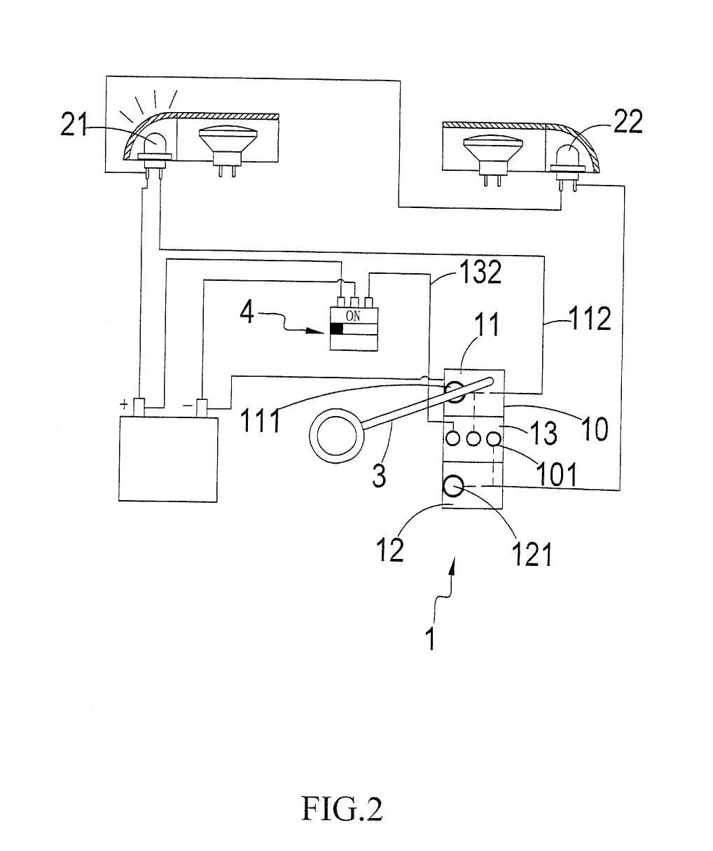

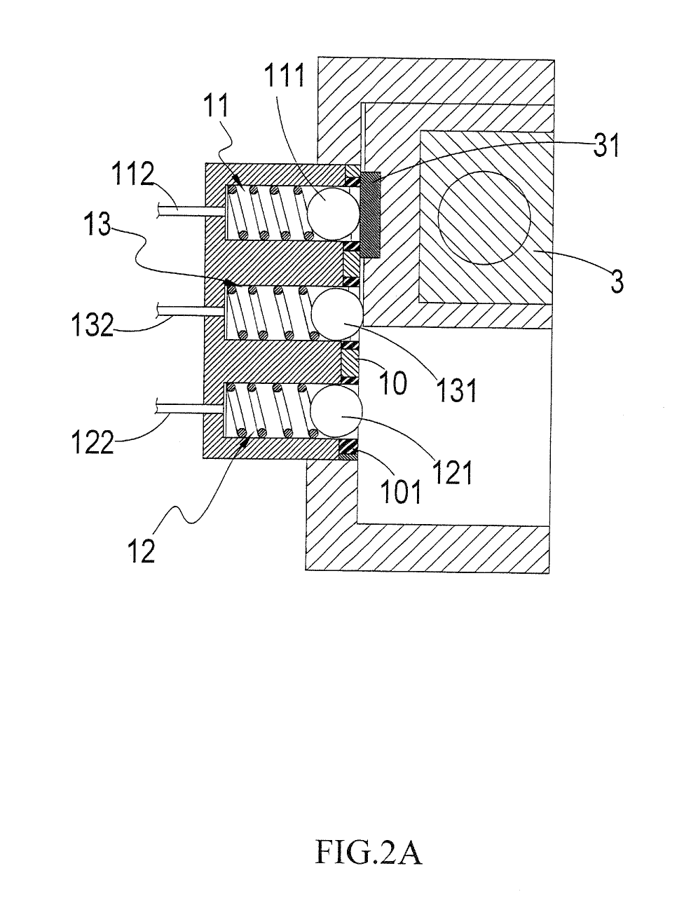

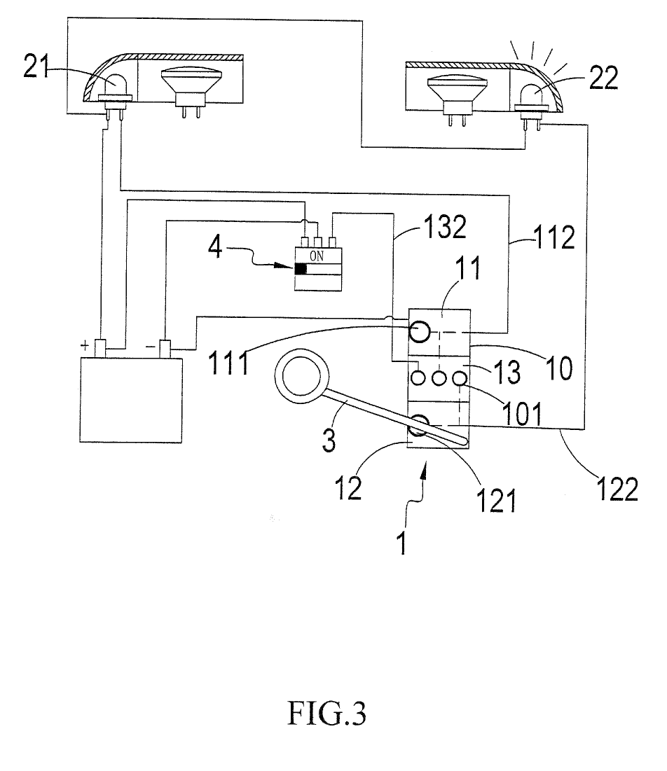

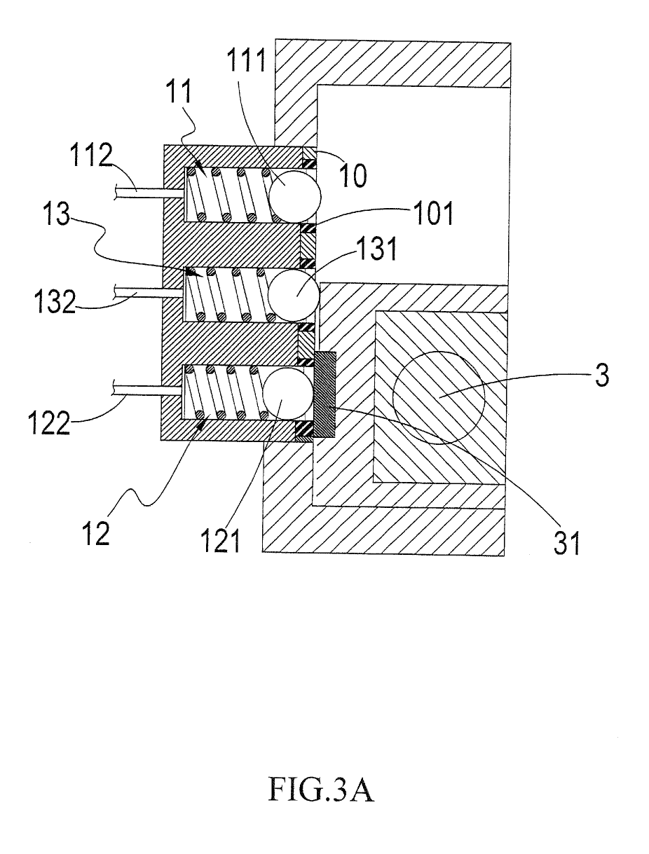

As shown in FIGS. 2 and 2A, the first connecting means 11 includes a first conducting strip 111, which can match with the conducting portion 31 of the movable shaft 3, and a first electrical line 112, which is arranged corresponding to the first conducting strip 111 and electrically connected to the first signal indicator 21. As shown in FIGS. 3 and 3A, the second connecting means 12 includes a second conducting strip 121, which can match with the conducting portion 31 of the movable shaft 3, and a second electrical line 122, which is arranged corresponding to the second conducting strip 121 and electrically connected to the second signal indicator 22. As shown in FIGS. 1 and 1A, the third connecting means 13 includes a third conducting strip 131, which can match with the conducting portion 31 of the movable shaft 3, and a third electrical line 132, which is arranged corresponding to the third conducting strip 131 and electrically connected to the warning signal switch 4, the function of which will be detailed in the following.

The following will illustrate the operation for the above architecture with reference to the accompanying drawings. Referring to FIGS. 1 and 1A, as described above, the third connecting means 13 includes a third conducting strip 131, which can match with the conducting portion 31 of the movable shaft 3, and a third electrical line 132, which is arranged corresponding to the third conducting strip 131 and electrically connected to the warning signal switch 4. As shown, when the movable arm 3 is not positioned corresponding to the third connecting means 13, the third conducting strip 131 is electrically disconnected from the conducting pad 10 by the insulating member 101. When the movable arm 3 is moved corresponding to the third connecting means 13, the third conducting strip 131 can be electrically connected with the conducting pad 10 by the conducting portion 31 of the movable arm 3. Under this condition, if the warning signal switch 4 is switched on, the third conducting strip 131 can engage with the third electrical line 132 to form two electrical loops respectively for the first signal indicator 21 and the second signal indicator 22 so that the first signal indicator 21 and the second signal indicator 22 can be turned on to flicker at the same time to indicate a warning signal of a vehicle. The warning signal may express an abnormal condition of the vehicle.

Referring to FIGS. 2 and 2A, as described above, the first connecting means 11 includes a first conducting strip 111, which can match with the conducting portion 31 of the movable shaft 3, and a first electrical line 112, which is arranged corresponding to the first conducting strip 111 and electrically connected to the first signal indicator 21. As shown, the warning signal switch 4 is switched on. When the conducting portion 31 of the movable shaft 3 is not positioned corresponding to the first conducting strip 111, the first conducting strip 111 is electrically disconnected from the conducting pad 10 by the insulating member 101. When the conducting portion 31 of the movable shaft 3 is positioned corresponding to the first conducting strip 111, the first conducting strip 111 can be electrically connected with the conducting pad 10 and the first conducting strip 111 can engage with the first electrical line 112 to form an electrical loop for the first signal indicator 21 so that the first signal indicator 21 can be turned on to flicker to indicate a turning direction of a vehicle. The first signal indicator may be a signal light on one side of the vehicle. In such condition, even though the warning signal switch 4 is switched on, since there is no electrical loop being formed for the second signal indicator 22, the second signal indicator 22 will not be turned on to flicker.

Referring to FIGS. 3 and 3A, as described above, the second connecting means 12 includes a second conducting strip 121, which can match with the conducting portion 31 of the movable shaft 3, and a second electrical line 122, which is arranged corresponding to the second conducting strip 121 and electrically connected to the second signal indicator 22. As shown, the warning signal switch 4 is switched on. When the conducting portion 31 of the movable shaft 3 is not positioned corresponding to the second conducting strip 121, the second conducting strip 121 is electrically disconnected from the conducting pad 10 by the insulating member 101. When the conducting portion 31 of the movable shaft 3 is positioned corresponding to the second conducting strip 121, the second conducting strip 121 can be electrically connected with the conducting pad 10 and the second conducting strip 121 can engage with the second electrical line 122 to form an electrical loop for the second signal indicator 22 so that the second signal indicator 22 can be turned on to flicker to indicate a turning direction of a vehicle. The second signal indicator 22 may be a signal light on the other side of the vehicle. In such condition, even though the warning signal switch 4 is switched on, since there is no electrical loop being formed for the first signal indicator 21, the first signal indicator 21 will not be turned on to flicker.

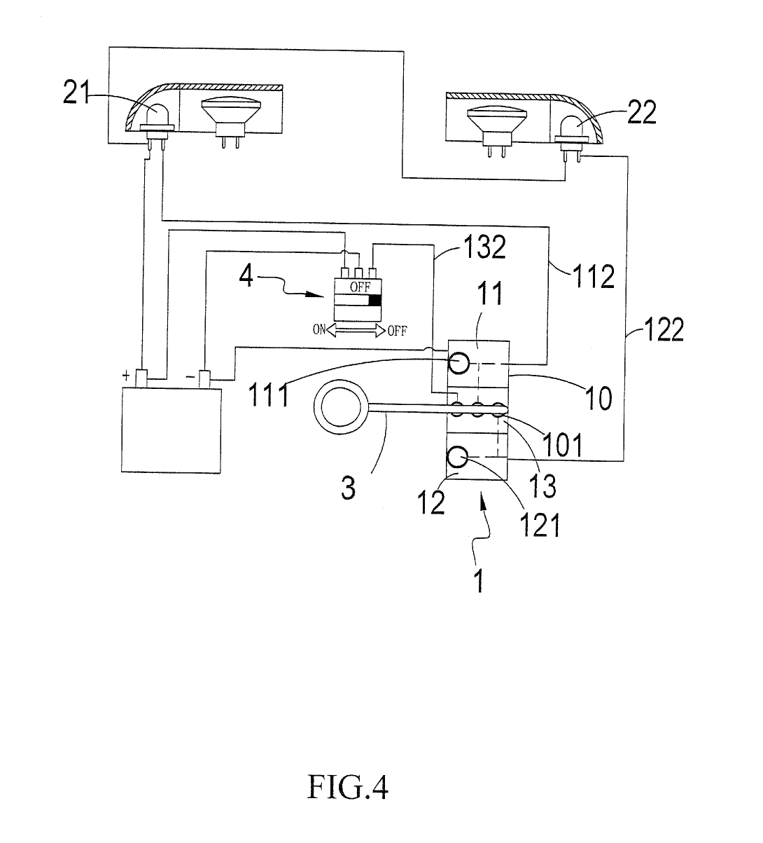

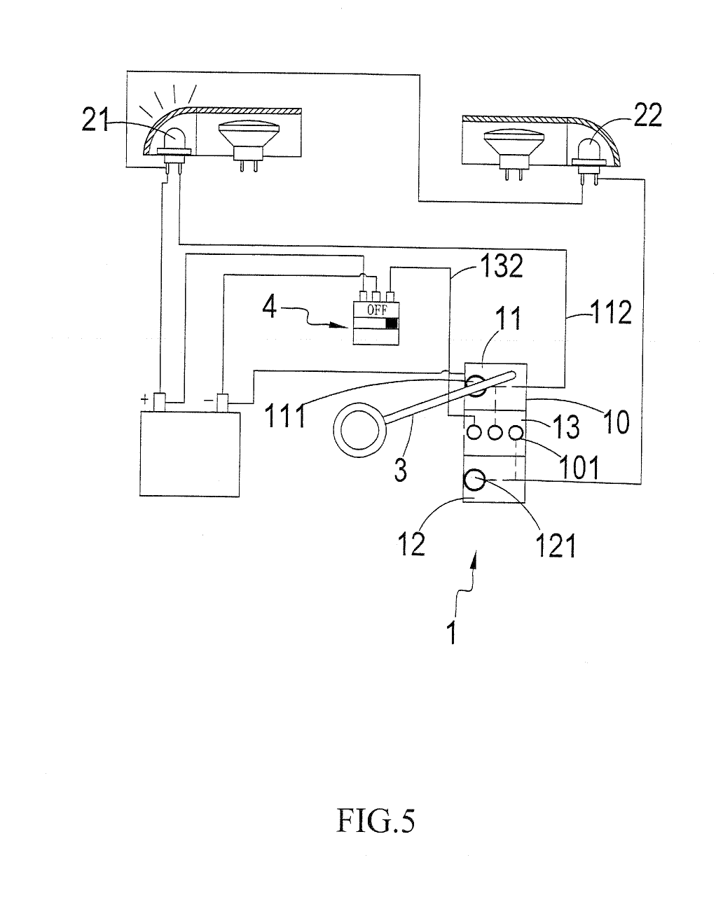

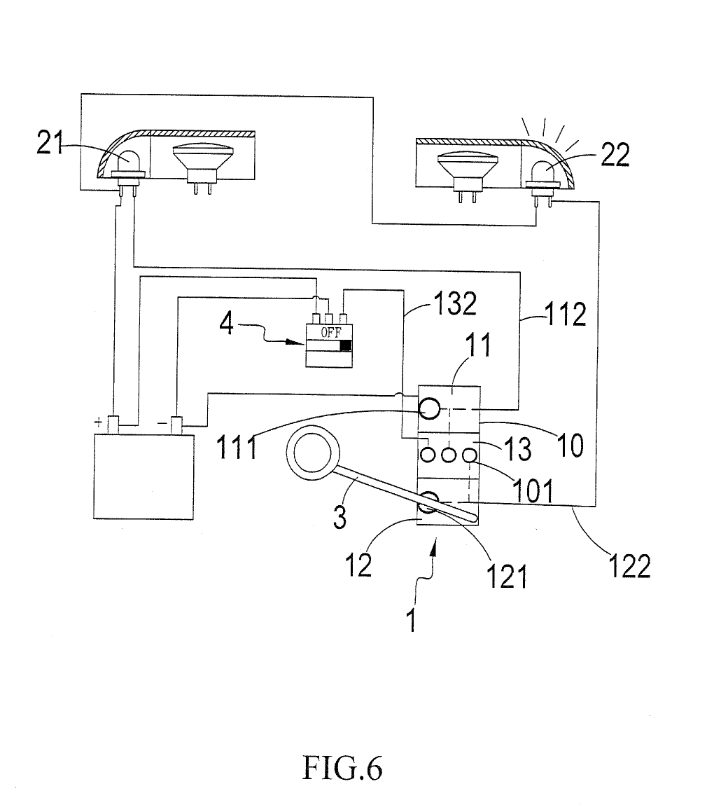

Referring to FIGS. 4, 5 and 6, as described above, the third connecting means 13 includes a third conducting strip 131, which can match with the conducting portion 31 of the movable shaft 3, and a third electrical line 132, which is arranged corresponding to the third conducting strip 131 and electrically connected to the warning signal switch 4. As shown in FIG. 4, although the conducting portion 31 of the movable shaft 3 is positioned corresponding to the third conducting strip 131 and the conducting strip 131 is electrically connected with the conducting pad 10, since the warning signal switch 4 is switched off, it is impossible to form electrical loops respectively for the first signal indicator 21 and the second signal indicator 22, and thus the first signal indicator 21 and the second signal indicator 22 will keep at off state. In such condition, when the movable shaft 3 is moved to the first connecting means 11 or the second connecting means 12, although the warning signal switch 4 is switched off, the first signal indicator 21 or the second signal indicator 22 can be still turned on to flicker to indicate a turning direction of a vehicle.

As a summary, the present invention has the following features and advantages:

1. When the movable shaft 3 is moved to an end position of the control assembly 1, corresponding to the first connecting means 11 or the second connecting means 12, the first signal indicator 21 and the second signal indicator 22 will always functioned as a directional indicator, under which it is impossible for the two signal indicators to be turned on to flicker at the same time, as seen in the conventional devices. This feature may improve the safety of driving vehicles.

2. When the movable shaft 3 is moved to a middle position of the control assembly 1, corresponding to the third connecting means 13, when the warning signal switch 4 is switched on, the first signal indicator 21 and the second signal indicator 22 can function as a warning indicator, under which both of the signal indicators 21, 22 can be turned on to flicker at the same time to indicate an abnormal condition of a vehicle.

3. The components and wiring of the present invention can be simplified to allow the present invention to be an economical design.

In light of the foregoing, the present invention can improve the safety of driving vehicles and simplify the components and wiring thereof to be an economical design, it is therefore a useful creation with novelty. An early and favorable action is respectfully solicited.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An architecture for controlling signal lights of vehicles, comprising:
a control assembly including a first connecting means for controlling a first signal indicator, a second connecting means for controlling a second signal indicator, and a third connecting means for controlling said first signal indicator and said second signal indicator;
a movable shaft being provided with at least one conducting portion for cooperating with said first connecting means, said second connecting means, and said third connecting means to generate a corresponding effect of signal indication; and
a warning signal switch being arranged corresponding to said third connecting means and said movable shaft, said warning signal switch being electrically connected to said first signal indicator and said second signal indicator.

2. An architecture for controlling signal lights of vehicles as claimed in claim 1, wherein said control assembly is mounted with conducting pads and insulating members for said first connecting means, said second connecting means, and said third connecting means.

3. An architecture for controlling signal lights of vehicles as claimed in claim 1, wherein said first connecting means includes a first conducting strip matchable with said conducting portion of said movable shaft and a first electrical line being arranged corresponding to said first conducting strip and being electrically connected to said first signal indicator.

4. An architecture for controlling signal lights of vehicles as claimed in claim 3, wherein when said conducting portion of said movable shaft is positioned corresponding to said first conducting strip of said first connecting means, said first signal indicator can be turned on to flicker by engaging said first conducting strip with said first electrical line to form an electrical loop.

5. An architecture for controlling signal lights of vehicles as claimed in claim 1, wherein said second connecting means includes a second conducting strip matchable with said conducting portion of said movable shaft and a second electrical line being arranged corresponding to said second conducting strip and being electrically connected to said second signal indicator.

6. An architecture for controlling signal lights of vehicles as claimed in claim 5, wherein when said conducting portion of said movable shaft is positioned corresponding to said second conducting strip of said second connecting means, said second signal indicator can be turned on to flicker by engaging said second conducting strip with said second electrical line to form an electrical loop.

7. An architecture for controlling signal lights of vehicles as claimed in claim 1, wherein said third connecting means includes a third conducting strip matchable with said conducting portion of said movable shaft and a third electrical line being arranged corresponding to said third conducting strip and being electrically connected to said warning signal switch.

8. An architecture for controlling signal lights of vehicles as claimed in claim 7, wherein when said warning signal switch is switched on and said conducting portion of said movable shaft is positioned corresponding to said third conducting strip of said third connecting means, said first signal indicator and said second signal indicator can be turned on to flicker by engaging said third conducting strip with said third electrical line to form electrical loops.

9. An architecture for controlling signal lights of vehicles as claimed in claim 7, when said warning signal switch is switched off and said conducting portion of said movable shaft is positioned corresponding to said third conducting strip of said third connecting means, said first signal indicator and said second signal indicator will keep at off state due to said warning signal switch being switched off.
